(19) United States
(12) Patent Application Publication
(10) Pub. No.: US 2026/0260895 A1
(43) Pub. Date: Sep. 3, 2026

(54) ALL-SOLID-STATE BATTERY

(71) Applicant: SAMSUNG ELECTRO-MECHANICS CO., LTD., Suwon-si, Gyeonggi-do (KR)

(72) Inventors: Taehoon Kim, Suwon-si, Gyeonggi-do (KR); Dongwon Kim, Suwon-si, Gyeonggi-do (KR); Myung Jin Jung, Suwon-si, Gyeonggi-do (KR); Jongmin Kim, Suwon-si, Gyeonggi-do (KR); Han Kim, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/729,084

(22) PCT Filed: May 27, 2024
(86) PCT No.: PCT/KR2024/007183

§ 371 Date: Jul. 15, 2024

(30) Foreign Application Priority Data
Dec. 27, 2023 (KR) 10-2023-0192909

(51) Int. Cl. H01M 4/62; H01M 4/02; H01M 4/36; H01M 4/66; H01M 10/0585

(52) U.S. Cl. CPC H01M 4/628; H01M 4/366; H01M 4/661; H01M 10/0585; H01M 2004/028

(57) ABSTRACT

An all-solid-state battery includes: a solid electrolyte layer, a positive electrode layer and a negative electrode layer facing each other with the solid electrolyte layer therebetween, a first external electrode connected to the positive electrode layer, a second external electrode connected to the negative electrode layer, and a positive electrode margin unit disposed between the positive electrode layer and the second external electrode. The positive electrode margin unit includes a main layer and an auxiliary layer having a shrinkage rate lower than that of the main layer.

### TECHNICAL FIELD

The present disclosure relates to an all-solid-state battery.

### BACKGROUND ART

As a long-term use of portable electronic devices becomes common, higher capacity batteries are demanded and with the spread of wearable electronic devices, there is a demand to ensure battery safety. Accordingly, all-solid-state batteries which use solid electrolytes, instead of liquid electrolytes, are actively being developed.

The all-solid-state battery is a battery which replaces the existing liquid electrolyte with a solid electrolyte to significantly improve the risk of explosion due to the flammability of the liquid electrolyte and does not use the liquid electrolyte to perform a stable operation under a severe environment of a high temperature and a high pressure. Further, cells are laminated without a separate cooling unit so that a high energy density can be achieved in the same volume and future use is expected.

Recently, the use of the negative electrode including silicon (Si) has become common so that the thickness difference between the positive electrode layer and the negative electrode layer has increased. However, there is a problem in that as the thickness difference between the positive electrode layer and the negative electrode layer is increased, a crack may be caused in the all-solid-state battery.

### DISCLOSURE OF INVENTION

### Technical Problem

The present disclosure attempts to provide an all-solid-state battery which prevents the crack.

### Solution to Problem

An embodiment of the present disclosure provides an all-solid-state battery including: a solid electrolyte layer, a positive electrode layer and a negative electrode layer facing each other with the solid electrolyte layer therebetween, a first external electrode connected to the positive electrode layer, a second external electrode connected to the negative electrode layer, and a positive electrode margin unit disposed between the positive electrode layer and the second external electrode. The positive electrode margin unit includes a main layer and an auxiliary layer having a shrinkage rate lower than that of the main layer.

Further, the main layer may be disposed on the auxiliary layer in a direction which the positive electrode layer and the negative electrode layer face each other.

Further, the main layer may include a first main layer and a second main layer. The auxiliary layer may be disposed on the first main layer and the second main layer may be disposed on the auxiliary layer, in a direction which the positive electrode layer and the negative electrode layer face each other.

Further, the auxiliary layer of the positive electrode margin unit may include aluminum (Al).

Further, the auxiliary layer of the positive electrode margin unit may include aluminum oxide in at least a part of a surface of the auxiliary layer.

Further, the auxiliary layer may include at least 10 wt % of solid electrolyte.

Further, the main layer of the positive electrode margin unit may include a glass ceramic based electrolyte.

Further, a thickness of the positive electrode layer may be larger than a thickness of the negative electrode layer in a direction which the positive electrode layer and the negative electrode layer face each other.

Further, the positive electrode layer may include a current collector and a pair of positive electrode active material layers disposed on both surfaces of the current collector, the negative electrode layer may include a negative electrode active material layer, the thickness of the positive electrode layer may be a sum of a thickness of the current collector and thicknesses of the pair of positive electrode active material layers, and the thickness of the negative electrode layer may be a the thickness of the negative electrode active material layer.

Further, a ratio of the thickness of the positive electrode layer to the thickness of the negative electrode layer may be 1.2 or higher.

Further, the positive electrode layer may be connected to the first external electrode and the positive electrode layer may be insulated from the second external electrode by the positive electrode margin unit.

Another embodiment of the present disclosure provides an all-solid-state battery including: a first inner electrode layer, a second inner electrode layer thicker than the first inner electrode layer, a solid electrolyte layer disposed between the first inner electrode layer and the second inner electrode layer, a first external electrode connected to the second inner electrode layer, a second external electrode connected to the first inner electrode layer, and a first margin unit disposed between the second inner electrode layer and the second external electrode. The first margin unit includes a first layer and a second layer having a shrinkage rate lower than that of the first layer.

Further, the first layer may be disposed on the second layer in a direction which the first inner electrode layer and the second inner electrode layer face each other.

Further, the second layer may include aluminum (Al).

Further, the second layer may include aluminum oxide on at least a part of a surface.

Another embodiment of the present disclosure provides an all-solid-state battery including: a solid electrolyte layer, a positive electrode layer and a negative electrode layer facing each other with the solid electrolyte layer therebetween, a first external electrode connected to the positive electrode layer, a second external electrode connected to the negative electrode layer, and a positive electrode margin unit disposed between the positive electrode layer and the second external electrode. The positive electrode margin unit includes a main layer and an auxiliary layer. A weight ratio of a weight of aluminum (Al) in the auxiliary layer to a total weight of the auxiliary layer is greater than a weight ratio of a weight of aluminum (Al) in the main layer to a total weight of the main layer.

Further, a weight ratio of a weight of solid electrolyte in the auxiliary layer to the total weight of the auxiliary layer is less than a weight ratio of a weight of solid electrolyte in the main layer to the total weight of the main layer.

### Advantageous Effects of Invention

According to at least one embodiment among embodiments, an auxiliary layer having a low shrinkage rate is disposed in a margin unit of a positive electrode layer so that even though the thickness difference between the positive electrode layer and the negative electrode layer is large, the crack of the all-solid-state battery may be suppressed.

### BRIEF DESCRIPTION OF DRAWINGS

FIG. 1 is a perspective view of an all-solid-state battery according to an embodiment.

FIG. 2 is a perspective view illustrating a battery main body of an all-solid-state battery illustrated in FIG. 1.

FIG. 3 is a right perspective view of a battery main body illustrated in FIG. 2.

FIG. 4 is a cross-sectional view taken along the IV-IV′ line of FIG. 1.

FIG. 5 is an enlarged view of a portion A of FIG. 4.

FIG. 6 is a cross-sectional view according to another embodiment.

### MODE FOR THE INVENTION

In the following detailed description, only certain embodiments of the present invention have been shown and described, simply by way of illustration. The drawings and description are to be regarded as illustrative in nature and not restrictive. Like reference numerals designate like elements throughout the specification. Further, some constituent elements in the drawing may be exaggerated, omitted, or schematically illustrated, and a size of each constituent element does not reflect the actual size entirely.

Further, the accompanying drawings are provided for helping to easily understand embodiments disclosed in the present specification, and the technical spirit disclosed in the present specification is not limited by the accompanying drawings, and it will be appreciated that the present invention includes all of the modifications, equivalent matters, and substitutes included in the spirit and the technical scope of the present invention.

Terms including an ordinal number, such as first and second, are used for describing various constituent elements, but the constituent elements are not limited by the terms. The terms are used only to discriminate one constituent element from another constituent element.

Further, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is “on” a reference portion, the element is located above or below the reference portion, and it does not necessarily mean that the element is located “above” or “on” in a direction opposite to gravity.

In the present application, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance. Accordingly, unless explicitly described to the contrary, the word “comprise”, and variations such as “comprises” or “comprising”, will be understood to imply the inclusion of stated elements but not the exclusion of any other elements.

Further, in the entire specification, when it is referred to as “on a plane”, it means when a target part is viewed from above, and when it is referred to as “on a cross-section”, it means when the cross-section obtained by cutting a target part vertically is viewed from the side.

Throughout the specification, when it is referred to as “connected”, this does not only mean that two or more constituent elements are directly connected, but may mean that two or more constituent elements are indirectly connected through another constituent element, are physically connected, electrically connected, or are integrated even though two or more constituent elements are referred as different names depending on a location and a function.

When the all-solid-state battery is described in the present specification, a direction in which main configurations of the all-solid-state battery are laminated is defined as a lamination direction, and this may be a ‘thickness direction. Further, a direction parallel to a plane which is perpendicular to the lamination direction may be defined as a ‘planar direction’ and the planar direction may include a ‘first direction’ and a ‘second direction’ which are orthogonal to each other.

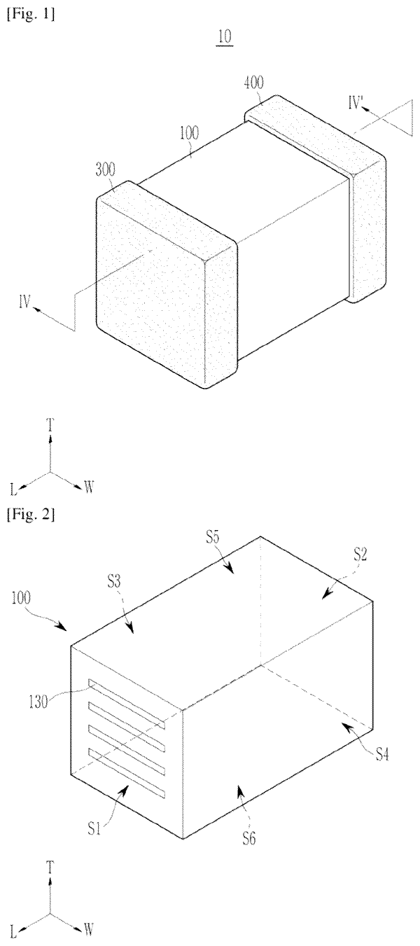

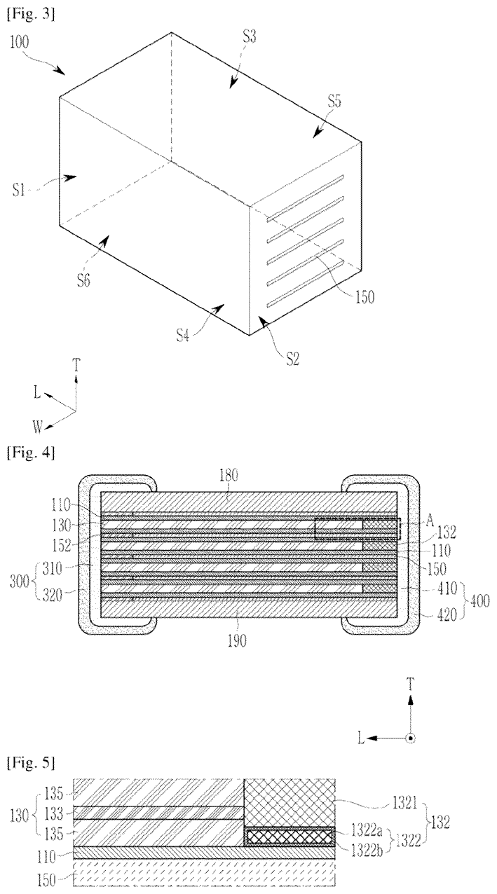

FIG. 1 is a perspective view schematically illustrating an all-solid-state battery 10 according to an embodiment. FIG. 2 is a perspective view schematically illustrating a battery main body 100 of an all-solid-state battery 10 illustrated in FIG. 1. FIG. 3 is a right perspective view of a battery main body 100 illustrated in FIG. 2. FIG. 4 is a cross-sectional view taken along the IV-IV′ line of FIG. 1.

Referring to FIGS. 1, 2, 3, and 4, an all-solid-state battery 10 according to the present embodiment includes a battery main body 100, a first external electrode 300, and a second external electrode 400.

First, in order to clearly describe the present embodiment, a direction is defined such that an L axis, a W axis, and a T axis illustrated in the drawings indicate a length direction, a width direction, and a thickness direction of the all-solid-state battery 10, respectively.

The thickness direction (T axis direction) may be a direction perpendicular to a wide plane (main plane) of components having a sheet shape. For example, the thickness direction (T axis direction) may be used as the same concept as the direction in which components of the battery main body 100 are laminated.

The length direction (L axis direction) is a direction parallel to a wide surface (main surface) of components having a sheet shape and may be a direction intersecting (or vertical to) the thickness direction (T axis direction). For example, the length direction (L axis direction) is a direction in which the first external electrode 300 and the second external electrode 400 face each other.

The width direction (W axis direction) is a direction parallel to the wide surface (main surface) of components having a sheet shape and may be a direction which simultaneously intersects (or is vertical to) the thickness direction (T axis direction) and the length direction (L axis direction).

The battery main body 100 has a substantially hexahedral shape, but the present embodiment is not limited thereto. Due to shrinkage during sintering, the battery main body 100 may not have a complete hexahedral shape, but may have a substantially hexahedral shape. For example, the battery main body 100 has a substantially rectangular parallelepiped shape, but a part corresponding to a corner or a vertex may have a round shape.

In the present embodiment, for better understanding and ease of description, surfaces facing each other in the length direction (L axis direction) are defined as a first surface S1 and a second surface S2, surfaces facing each other in the width direction (W axis direction) and connect the first surface S1 and the second surface S2 are defined as a third surface S3 and a fourth surface S4, and surfaces facing each other in the thickness direction (T axis direction) and connect the first surface S1 and the second surface S2 are defined as a fifth surface S5 and a sixth surface S6.

Accordingly, the first direction in which the first surface S1 and the second surface S2 face each other is a length direction (L axis direction) and the second direction and the third direction which are perpendicular to the first direction and are perpendicular to each other are a thickness direction (T axis direction) and a width direction (W axis direction) or a width direction (W axis direction) and a thickness direction (T axis direction).

The length of the ceramic main body 10 may mean, based on an optical microscope or scanning electron microscope (SEM) photograph of the length direction (L-axis direction)-thickness direction (T-axis direction) cross-section at a width direction (W-axis direction) central portion of the ceramic main body 10, the maximum value among the lengths of a plurality of line segments each connecting two outermost boundary lines facing each other in the length direction (L-axis direction) of the ceramic main body 10, which is shown in the above-described cross-sectional photograph, and parallel to the length direction (L-axis direction). Hereinafter, the length direction (L-axis direction)-thickness direction (T-axis direction) cross-section means a cross-section where the length direction (L-axis direction) and the thickness direction (T-axis direction) intersect (or are perpendicular to) each other. In the meantime, the length of the ceramic main body 10 may mean the minimum value among the lengths of a plurality of line segments each connecting two outermost boundary lines facing each other in the length direction (L-axis direction) of the ceramic main body 10, which is shown in the above-described cross-sectional photograph, and parallel to the length direction (L-axis direction). On the other hand, the length of the ceramic main body 10 may mean an arithmetic average value of the lengths of at least two line segments among a plurality of line segments each connecting two outermost boundary lines facing each other in the length direction (L-axis direction) of the ceramic main body 10, which is shown in the above-described cross-sectional photograph, and parallel to the length direction (L-axis direction).

The thickness of the battery main body 100 may mean, based on an optical microscope or SEM photograph of the length direction (L-axis direction)-thickness direction (I-axis direction) cross-section at a width direction (W-axis direction) central portion of the battery main body 100, the maximum value among the lengths of a plurality of line segments each connecting two outermost boundary lines facing each other in the thickness direction (T-axis direction) of the battery main body 100, which is shown in the above-described cross-sectional photograph, and parallel to the thickness direction (T-axis direction). In the meantime, the thickness of the battery main body 100 may mean a minimum value among the lengths of a plurality of line segments each connecting two outermost boundary lines facing each other in thickness direction (T-axis direction) of the battery main body 100, which is shown in the above-described cross-sectional photograph, and parallel to the thickness direction (T-axis direction). On the other hand, the thickness of the battery main body 100 may mean an arithmetic average value of the lengths of at least two line segments among a plurality of line segments each connecting the two outermost boundary lines facing each other in the thickness direction (T-axis direction) of the battery main body 100, which is shown in the above-described cross-sectional photograph, and parallel to the thickness direction (T-axis direction).

The width of the battery main body 100 may mean, based on an optical microscope or SEM photograph of the width direction (W-axis direction) cross-section at a thickness direction (f-axis direction) central portion of the battery main body 100, the maximum value among the lengths of a plurality of line segments each connecting two outermost boundary lines facing each other in the width direction (W-axis direction) of the battery main body 100, which is shown in the above-described cross-sectional photograph, and parallel to the width direction (W-axis direction). Hereinafter, the length direction (L-axis direction)-width direction (W-axis direction) cross-section means a cross-section where the length direction (L-axis direction) and the width direction (W-axis direction) intersect (or are perpendicular to) each other. In the meantime, the width of the battery main body 100 may mean a minimum value among the lengths of the plurality of line segments each connecting two outermost boundary lines facing each other in the width direction (W-axis direction) of the battery main body 100, which is shown in the above-described cross-sectional photograph, and parallel to the width direction (W-axis direction). On the other hand, the width of the battery main body 100 may mean an arithmetic average value of the length of at least two line segments among a plurality of line segments each connecting the two outermost boundary lines facing each other in the width direction (W-axis direction) of the battery main body 100, which is shown in the above-described cross-sectional photograph, and parallel to the width direction (W-axis direction).

The battery main body 10) includes a solid electrolyte layer 110, a positive electrode layer 130, a negative electrode layer 150, a positive electrode margin unit 132, a negative electrode margin unit 152, an upper protection layer 180, and a lower protection unit 190.

Each of the solid electrolyte layers 110, the positive electrode layers 130, and the negative electrode layers 150 may be plural. The plurality of positive electrode layer 130 and the plurality of negative electrode layers 150 may be alternately laminated in the thickness direction (T axis direction) with the solid electrolyte layers 110 therebetween. In other words, the positive electrode layer 130 and the negative electrode layer 150 face each other in the thickness direction (T axis direction) with the solid electrolyte layer 110 therebetween. For example, in the thickness direction (T axis direction), the negative electrode layer 150, the solid electrolyte layer 110, the positive electrode layer 130, the solid electrolyte layer 110, and the negative electrode layer 150 may be sequentially laminated. That is, the positive electrode layer 130 and the negative electrode layer 150 may face each other with the solid electrolyte layer 110 therebetween. The positive electrode layer 130 and the negative electrode layer 150 may be defined as a first internal electrode layer and a second internal electrode layer, or a second internal electrode layer and a first internal electrode layer.

With reference to the solid electrolyte layer 110, the positive electrode layer 130 is disposed on one surface of the solid electrolyte layer 110 and the negative electrode layer 150 is disposed on the other surface of the solid electrolyte layer 110.

The solid electrolyte layer 110 includes a solid electrolyte. The solid electrolyte serves as a passage of lithium (Li) ions. A solid electrolyte included in the solid electrolyte layer 110 may include a glass-ceramic based electrolyte including lithium-halogen LiX, X=halogen element, such as F, Br, Cl, I). The glass-ceramic (or crystallized glass) refers to crystallographic mixture of an amorphous material and a crystalline material. For example, peaks or halos observed in the X-ray diffraction or electron beam diffraction may indicate a crystallographic mixture of amorphous and a crystalline material. Accordingly, the glass-ceramic based electrolyte is partially crystallized by the sintering so that the amorphous materials and the crystalline materials coexist.

In the glass-ceramic based electrolyte, the amorphous material and two types or more of crystalline materials may coexist. Further, the crystalline material included in the glass-ceramic based electrolyte may include a lithium compound crystalline phase including lithium.

When the glass-ceramic based electrolyte is included, the densification is sufficiently performed after sintering so that high ion conductivity may be achieved.

The glass-ceramic based electrolyte includes lithium (Li) oxide, boron (B) oxide, silicon (Si) oxide, aluminum (Al) oxide, gallium (Ga) oxide, phosphorus (P) oxide, germanium (Ge) oxide, magnesium (Mg) oxide, and lithium chloride (LiCl). For example, the glass-ceramic based electrolyte includes Li₂O—B₂O₃—SiO₂—P₂O₅—GeO₂—LiCl.

The solid electrolyte included in the solid electrolyte layer 110 may include a lithium borosilicate based electrolyte (hereinafter, referred to as LBSO based electrolyte). The LBSO based electrolyte is a glass state electrolyte. The glass is crystallographically amorphous and a halo may be observed in the X-ray diffraction or the electron beam diffraction. When the solid electrolyte layer 110 includes the LBSO based electrolyte, a sintering temperature is lowered and the amorphous state may be maintained during the sintering. Accordingly, a high ion conductivity can be implemented and it is advantageous in that the reactivity with the solid electrolyte layer 110 and the electrode is not so high. The LBSO based electrolyte may include lithium (Li), boron (B), silicon (Si), aluminum (Al), phosphorus (P), germanium (Ge), and sulfur (S).

Further, the solid electrolyte included in the solid electrolyte layer 110 may be one or more selected from a group consisting of garnet based, Nasicon based, LISiCON based, perovskite based, and UPON based solid electrolytes.

The garnet based solid electrolyte may mean a lithium lanthanum zirconium oxide (LLZO) expressed by LiₐLa_{b}Zr_{c}O₁₂ such as Li₇La₃Zr₂O₁₂ the Nasicon based solid electrolyte may mean lithium-aluminum-titanium-phosphate (LATP) of Li₁₊ₓAlₓTi₂₋ₓ (PO₄)₃ (0<x<1) with Ti introduced into Li₁₊ₓAlₓM₂₋ₓ (PO₄)₃(LAMP) (0<x<2, M=Zr, Ti, Ge) type compound, lithium-aluminum-germanium-phosphatic (LAGP) expressed by Li₁₊ₓAlₓGe₂₋ₓ (PO₄))₃ (0<x<1), such as Li_{1.3}Al_{0.3}Ge_{1.7} (PO₄)₃ with excess lithium introduced, and/or lithium-zirconium-phosphate (LZP) of LiZr₂ (PO₄)₃.

Further, the LISICON based solid electrolyte refers to a solid solution oxide which is expressed by xLi₃AO₄—(1−x)Li₄ BOₐ (A: P, As, or V, B: Si, Ge, or Ti) and includes a solid solution oxide including Li₄Zn (GeO₄)₄, Li₁₀GeP₂O₁₂(LGPO), Li_{3.5}Si_{0.5}P_{0.5}O₄, Li_{10.42}Si (Ge)_{1.5}P_{1.5}Cl_{0.08}O_{11.92} and a solid solution sulfide which includes Li₂S—P₂S₅, Li₂S—SiS₂, Li₂S—SiS₂—P₂S₅, Li₂S—GeS₂ expressed by Li₄₋ₓM_{1-y}M′_{y}S₄ (M=Si, Ge and M′=P, Al, Zn, Ga).

The perovskite based solid electrolyte may mean lithium-lanthanum-titanium-oxide (lithium lanthanum titanate, LLTO) expressed by Li₃ₓLa_{2/3-x}□_{1/3-2x}TiO₃ (0<x<0.16, vacancy) such as Li_{1/8}La_{3/8}TiO₃ and the LiPON based solid electrolyte refers to nitride such as lithium-phosphorus-oxynitride, Li_{2.8}PO_{3.3}N_{0.46}.

The positive electrode layer 130 may be exposed to the first surface S1 of the battery main body 100 and may be connected to the first external electrode 300. The positive electrode layer 130 may include a current collector 133 and a positive electrode active material layer 135.

The current collector 133 may be formed by a plate type member or a thin member, in one example. In another example, the current collector 133 may be formed by a porous body such as a network or a mesh shape.

The current collector 133 may be, for example, a porous metal plate formed of stainless steel, nickel (Ni), copper (Cu), tin (Sn), aluminum (Al), or an alloy thereof. Further, in order to prevent the oxidation of the current collector 133, the current collector 133 may be coated with an oxidation resistant metal or alloy film.

In the meantime, the current collector 133 may be formed by carbon-based plate shaped, thin, linear, or circular member. The current collector 133 may be formed by a conductive carbon material. For example, the conductive carbon material may be a conductive fiber, such as graphite, carbon nanotube (CNT) or vapor grown carbon fiber (VGCF) or a conductive carbon such as carbon black.

The current collector 133 may include one or more types of solid electrolyte.

The positive electrode active material layer 135 includes a positive electrode active material. The positive electrode active material layer 135 may be disposed on the surface of the current collector 133. The positive electrode active material layer 135 may be formed by printing the positive electrode active material on one surface or both surfaces of the current collector 133, but the method for forming the positive electrode active material layer 135 is not limited thereto.

The positive electrode active material which is included in the positive electrode active material layer 135 may be a material including lithium (Li) ions. The positive electrode active material reversibly intercalates and deintercalates the lithium ions. That is, the positive electrode active material may include the lithium ions and then serve to provide the lithium ions to the negative electrode when the all-solid-state battery 10 is charged. The positive electrode active material affects a capacity and an output of the all-solid-state battery 10.

For example, the positive electrode active material is a compound expressed by the following formula. LiₐA_{1-b}M_{b}D₂ (in Formula, 0.90≤a≤1.8, 0≤b≤0.5); LiₐE_{1-b}M_{b} O_{2-c}D_{c} (in Formula, 0.90≤a≤1.8, 0≤b≤0.5, 0≤c≤0.05); LiE_{2-b}M_{b}O_{4-c}D_{c} (in Formula, 0≤b≤0.5, 0≤c≤0.05); LiₐNi_{1-b-c}Co_{b}M_{c}D_{α} (in Formula, 0.90≤a≤1.8, 0≤b≤0.5, 0≤c≤0.05, 0<α≤2); LiₐNi_{1-b-c}Co_{b}M_{c}O_{2-α}X_{α}(in Formula, 0.90≤a≤1.8, 0≤b≤0.5, 0≤c≤0.05, 0<α<2); LiₐNi_{1-b-c}Co_{b}M_{c}O_{2-α}X₂ (in Formula, 0.90≤a≤1.8, 0≤b≤0.5, 0≤c≤0.05, 0<α≤2); LiₐNi_{1-b-c}Mn_{b}M_{c}D_{α} (in Formula, 0.90≤a≤1.8, 0≤b≤0.5, 0≤c≤0.05, 0<α≤2); LiₐNi_{1 b c}Mn_{b}M_{c}O_{2-α}X_{α} (in Formula, 0.90≤a≤1.8, 0≤b≤0.5, 0≤c≤0.05, 0<α≤2); LiₐNi_{1-b-c}Mn_{b}M_{c}C_{2 α}X₂ (in Formula, 0.90≤a≤1.8, 0≤b≤0.5, 0≤c≤0.05, 0<α≤2); LiₐNi_{b}E_{c}G_{c}O₂ (in Formula, 0.90≤a≤1.8, 0≤b≤0.9, 0≤c≤0.5, 0.001≤d≤0.1); LiₐNi_{b}Co_{c}Mn_{d}GₑO₂ (in Formula, 0.90≤a≤1.8, 0≤b≤0.9, 0≤c≤0.5, 0≤d≤0.5, 0.01≤e≤0.1); LiₐNiG_{b}O₂ (in Formula, 0.90≤a≤1.8, 0.001≤b≤0.1); LiₐCoG_{b}O₂ (in Formula, 0.90≤a≤1.8, 0.001≤b≤0.1); LiₐMnG_{b}O₂ (in Formula, 0.90≤a≤1.8, 0.001≤b≤0.1); LiₐMn₂G_{b}O₄ (in Formula, 0.90≤a≤1.8, 0.001≤b≤0.1); QO₂; QS₂; LiQS₂; V₂O₅; LiV₂O₂; LiRO₂; LiNiVO₄; Li_{(3-f)}J₂(PO₄)₃ (0≤f≤2); Li_{(3-f)}Fe₂(PO₄)₃ (in Formula, 0≤f≤2); and LiFePO₄, in the above formula, A is Ni, Co, or Mn; M is Al, Ni, Co, Mn, Cr, Fe, Mg, Sr, V, Nb, Ti or rare earth element; D is O, F, S, or P; E is Co or Mn: X is F, S, or P; G is Al, Cr, Mn, Fe, Mg, La, Ce, Sr, or V; Q is Ti, Mo or Mn; R is Cr, V, Fe, Sc, or Y; J is V, Cr, Mn, Co, Ni, or Cu.

The positive electrode active material is also LiCoO₂, LiMnₓO₂ₓ (in Formula, x=1 or 2), LiNi₁₋ₓMnₓO₂ₓ (in Formula, 0<x<1) LiNi_{1-x-y}CoₓMn_{y}O₂ (in Formula, 0≤x≤0.5, 0≤y≤0.5), LiFePO₄, TiS₂, FeS₂, TiS₃, or FeS₃, but is not limited thereto.

The positive electrode active material may selectively include a conductive material and a binder. However, the organic material, such as a binder, may not remain in the positive electrode active material layer 135 of the obtained positive electrode collector 133 because the organic material is decomposed during sintering.

The conductive material is not specifically limited as long as it has conductivity without causing a chemical change in the all-solid-state battery 10. For example, graphite such as natural graphite or artificial graphite; carbon based material such as carbon black, acetylene black, Ketjen black, channel black, furnace black, lamp black, or summer black; conductive fiber such as a carbon fiber or a metal fiber; fluoro carbon; a metal compound such as lithium (Li), tin (Sn), aluminum (Al), nickel (Ni), copper (Cu), oxide, nitride, or fluoride thereof; conductive whisker such as zinc oxide or potassium titanate; conductive metal oxide such as titanium oxide; and a conductive material such as a polyphenylene derivative may be used.

The binder may be used to improve the bonding force of the active material and the conductive material. As a material used for the binder, polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, ethylene-propylene-diene monomer (EPDM), sulfonated EPDM, styrene butadiene rubber, fluoro rubber and various copolymers may be used, but the material is not limited thereto.

The positive electrode layer 130 may further include a solid electrolyte component. The solid electrolyte component may be one or more of the above described components. The solid electrolyte component included in the positive electrode layer 130 may serve as an ion conducting channel in the positive electrode layer 130. By doing this, an interface resistance may be reduced.

The negative electrode layer 150 may be exposed to the second surface S2 of the battery main body 100 and connected to the second external electrode 400. The negative electrode layer 150 may include a negative electrode active material layer and the negative electrode layer 150 may be formed only by the negative electrode active material layer.

The negative electrode active material included in the negative electrode active material layer may store and release lithium ions that have migrated from the positive electrode during discharge of the all-solid-state battery to generate electrical energy. As the negative electrode active material, a carbon-based material, silicon, silicon oxide, silicon-based alloy, silicon-carbon-based material complex, tin, tin-based alloy, tin-carbon complex, metal oxide or a combination thereof may be used and lithium metal and/or lithium metal alloy may be included.

The lithium metal alloy may include lithium, and metal/metalloids capable of alloying with lithium. For example, metal/metalloids capable of alloying with lithium may be Si, Sn, Al, Ge, Pb, Bi, Sb, Si-AM alloy (the AM is alkali metal, alkaline-earth metal, 13 to 16 group elements, transition metal, rare earth element or combination thereof, but does not include Si), Sn-AM alloy (the AM is alkali metal, alkaline-earth metal, 13 to 16 group elements, transition metal, transition metal oxide such as lithium titanium oxide (Li₄Ti₅O₁₂), rare earth element or a combination thereof, but does not include Sn) and MnOₓ (0<x≤2).

The element AM may be Mg, Ca, Sr, Ba, Ra, Sc, Y, Ti, Zr, Hf, Rf, V, Nb, Ta, Db, Cr, Mo, W, Sg, Te, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

Further, oxide of the metal/metalloids capable of alloying with lithium may be lithium titanium oxide, vanadium oxide, lithium vanadium oxide. SnO₂, or SiOₓ (0<x<2). For example, the negative electrode active material may include one or more elements selected from Group 13 to Group 16 of the periodic table of elements. For example, the negative electrode active material may include one or more elements selected from a group consisting of Si, Ge, and Sn.

The carbon-based material may be crystalline carbon, amorphous carbon, or a mixture thereof. The crystalline carbon may be a graphite such as amorphous, a plate-shaped, flake-shaped, spherical, or fiber-shaped natural graphite or artificial graphite. The amorphous carbon may be soft carbon (low temperature fired carbon) or hard carbon, mesophase pitch carbide, fired coke, graphene, carbon black, fullerene soot, carbon nanotube, and carbon fiber, but is not limited thereto.

The silicon uses any one selected from a group consisting Si, SiOₓ (0<x<2, for example, 0.5 to 1.5), Sn, SnO₂, or silicon containing metal alloy, and a mixture thereof. The silicon containing metal alloy, for example, includes silicon and one or more of Al, Sn, Ag, Fe, Bi, Mg, Zn, In, Ge, Pb, and Ti.

The negative electrode active material selectively includes a conductive material and a binder.

The conductive material is not specifically limited as long as it has a conductivity without causing a chemical change in the all-solid-state battery 10. For example, graphite such as natural graphite or artificial graphite; carbon based material such as carbon black, acetylene black, Ketjen black, channel black, furnace black, lamp black, or summer black; conductive fiber such as a carbon fiber or a metal fiber; fluorinated carbon; a metal component such as lithium (Li), tin (Sn), aluminum (Al), nickel (Ni), copper (Cu), oxide, nitride, or fluoride thereof; conductive whisker such as zinc oxide or potassium titanate; conductive metal oxide such as titanium oxide; and a conductive material such as polyphenylene derivative may be used.

The binder may be used to improve the bonding force of the active material and the conductive material. As the binder, polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, ethylene-propylene-dienter polymer (EPDM), sulfonated EPDM, styrene butadiene rubber, fluoroelastomer and various copolymers may be used, but the binder is not limited thereto.

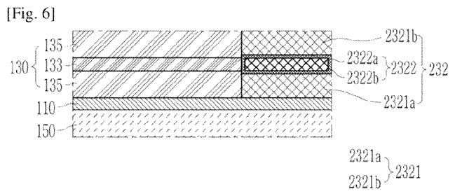

FIG. 5 is an enlarged cross-sectional view of portion A of FIG. 4.

Referring to FIGS. 4 and 5, the positive electrode margin unit 132 is disposed between the positive electrode layer 130 and the second external electrode 400 in the length direction (L axis direction). That is, the positive electrode margin unit 132 extends from an end portion of the positive electrode layer 130 toward the second surface S2 of the battery main body 100 in the length direction (L axis direction) to form a part of the second surface S2 of the battery main body 100. One end of the positive electrode layer 130 is electrically connected to the first external electrode 300 and the other end of the positive electrode layer 130 is in contact with the positive electrode margin unit 132 so that the positive electrode layer 130 is electrically insulated from the second external electrode 400 by the positive electrode margin unit 132.

The positive electrode margin unit 132 may include a main layer 1321 and an auxiliary layer 1322. The main layer 1321 and the auxiliary layer 1322 may be laminated in the thickness direction (T axis direction).

The main layer 1321 of the positive electrode margin unit 132 may be formed of an insulating material, that is, a material which does not have electron (ion) conductivity. The main layer 1321 of the positive electrode margin unit 132 may include a glass-ceramic based electrolyte including lithium-halogen (LiX, X halogen element such as F, Br, Cl, I). The glass-ceramic (or crystallized glass) refers to crystallographic mixture of an amorphous material and a crystalline material. For example, peaks or halos observed in the X-ray diffraction or electron beam diffraction may indicate a crystallographic mixture of amorphous and a crystalline material. Accordingly, the glass-ceramic based electrolyte is partially crystallized by the sintering so that the amorphous materials and the crystalline materials coexist.

The glass-ceramic based electrolyte may include a mixture of the amorphous material and two or more crystalline phases. Further, the crystalline material included in the glass-ceramic based electrolyte may include a lithium compound crystalline phase including lithium. The glass-ceramic based electrolyte may include lithium (Li) oxide, boron (B) oxide, silicon (Si) oxide, aluminum (Al) oxide, gallium (Ga) oxide, phosphorus (P) oxide, germanium (Ge) oxide, magnesium (Mg) oxide, and lithium chloride (LiCl). For example, the glass-ceramic based electrolyte may include Li₂O—B₂O₃—SiO₂—P₂O₅—GeO₂—LiCl.

For example, the main layer 1321 of the positive electrode margin unit 132 may include alumina (Al₂O₃), aluminum nitride (AlN), beryllium oxide (BeO), boron nitride (BN), silicon (Si), silicon carbide (SiC), silica (SiO₂), silicon nitride (Si₃N₄), gallium arsenide (GaAs), gallium nitride (GaN), barium titanate (BaTiO₃), zirconium dioxide (ZrO₂), a mixture thereof, oxide and/or nitride of the materials, or other appropriate ceramic materials. Further, the main layer 1321 of the positive electrode margin unit 132 may selectively include the above-described solid electrolyte. However, the material of the main layer 1321 is not limited thereto.

The main layer 1321 of the positive electrode margin unit 132 may include a material having low ion conductivity and low electron conductivity, that is, an insulating material, or include a material having ion conductivity (or electron conductivity) similar to the ion conductivity (or electron conductivity) of the solid electrolyte. For example, when a material having ion conductivity (or electron conductivity) similar to the ion conductivity (or electron conductivity) of the solid electrolyte is included in the main layer 1321 of the positive electrode margin unit 132, the material may be the same material as a solid electrolyte in another region or different material. As another example, both a material having ion conductivity (or electron conductivity) similar to the ion conductivity (or electron conductivity) of the solid electrolyte and an insulating material may be included in the main layer 1321 of the positive electrode margin unit 132.

For example, the main layer 1321 of the positive electrode margin unit 132 may have the same composition as the solid electrolyte layer 110. That is, the main layer 1321 of the positive electrode margin unit 132 may be formed with a solid electrolyte paste used to form the solid electrolyte layer 110. At this time, the main layer 1321 of the positive electrode margin unit 132 may be defined as a portion of the solid electrolyte layer 110 which extends to a side surface of the positive electrode layer 130. In other words, the main layer 1321 of the positive electrode margin unit 132 having the same composition as the solid electrolyte layer 110 is a pan of the solid electrolyte layer 110 which extends in the thickness direction (T axis direction).

The auxiliary layer 1322 of the positive electrode margin unit 132 may have an insulating property and a low shrinkage rate characteristic. The auxiliary layer 1322 may include an insulating material and a material having a low shrinkage rate. The auxiliary layer 1322 may include an inner region 1322a and a surface region 1322b.

The shrinkage rate may be shrinkage generated when pores in the battery main body 100 are filled. That is, after laminating the battery main body 100, pores are formed in the battery main body 100. Thereafter, when the battery main body 100 is sintered, the solid electrolyte is melted by applying a pressure to be filled in the pores. Accordingly, the shrinkage of the components of the battery main body 100 may be generated. When the battery main body 100 is sintered, the pressure is vertically applied so that the battery main body 100 is significantly shrunk in the thickness direction (T axis direction). Accordingly, the components of the battery main body 100 are also significantly shrunk in the thickness direction (T axis direction). The shrinkage of the components of the battery main body 100 in the length direction (L axis direction) or the width direction (W axis direction) may be much smaller than the shrinkage in the thickness direction (T axis direction).

Before and after sintering the battery main body 100, thicknesses of the components of the battery main body 100 are measured and compared to calculate the shrinkage rate. For example, when thicknesses of the positive electrode layer, the solid electrolyte layer, and the negative electrode layer are measured as [38 um->22 um], [30 um->13 um], and [38 um->20 um] ([before sintering->after sintering]), respectively, the shrinkage rates may be calculated as 42%, 57%, and 47%.

The inner region 1322a of the auxiliary layer 1322 may be formed of a material having a shrinkage rate lower than that of the main layer 1321. The inner region 1322a of the auxiliary layer 1322 may include aluminum (Al). Further, the inner region 1322a of the auxiliary layer 1322 may include the above-described solid electrolyte. For example, the inner region 1322a of the auxiliary layer 1322 may include 10 wt % or more of the solid electrolyte. At this time, the aluminum powder included in the auxiliary layer 1322 may be 90 wt % or lower. When 10 wt % or more of solid electrolyte is included in the auxiliary layer 1322, the strength of the all-solid-state battery may be improved to facilitate the manufacturing process of the all-solid-state battery.

As the difference in thickness between the positive electrode margin unit 132 and the negative electrode margin unit 152 is increased, the possibility of cracks occurring during the sintering process of the battery main body 100 is increased. The cracks are generated because the shrinkage rate of the positive electrode margin unit 132 and the negative electrode margin unit 152 is higher than that of the active material included in the positive electrode active material layer 135 and the negative electrode active material layer, when the positive electrode margin unit 132 and the negative electrode margin unit 152 are formed with the solid electrolyte as a main material. At this time, when the positive electrode margin unit 132 includes the auxiliary layer 1322 which is formed by a material having a low shrinkage rate, the imbalance of the shrinkage rate is relieved to prevent the crack of the battery main body 100. Accordingly, the short defect of the all-solid-state battery 10 which is caused by the crack of the battery main body 100 may be suppressed.

The surface region 1322b of the auxiliary layer 1322 has an insulating property. The surface region 1322b of the auxiliary layer 1322 may include aluminum oxide in at least a portion. For example, the surface region 1322b of the auxiliary layer 1322 is formed by an aluminum oxide film which encloses the inner region 1322a. The aluminum oxide film of the surface region 1322b may be formed by aluminum (Al) which is naturally oxidized on the surface. The auxiliary layer 1322 may have an insulating property by the aluminum oxide film of the surface region 1322b. That is, the auxiliary layer may have the low shrinkage rate property by aluminum included in the inner region 1322a and an insulating property by the aluminum oxide film of the surface region 1322b.

A thickness ratio between the main layer 1321 and the auxiliary layer 132, in the thickness direction (T axis direction), may vary depending on the composition ratio of aluminum (Al) and the solid electrolyte included in the auxiliary layer 1322. Further, the thickness ratio between the main layer 1321 and the auxiliary layer 1322 of the positive electrode margin unit 132 may vary depending on the thickness ratio between the positive electrode layer 130 and the negative electrode layer 150. For example, when a ratio of the thickness of the positive electrode layer 130 to the thickness of the negative electrode layer 150 is 1.22, the thickness of the auxiliary layer 1322 may be formed to be 10 um or larger and 30 um or smaller. However, the thickness of the auxiliary layer 1322 is not limited thereto and the thickness of the auxiliary layer 1322 may be changed by various conditions, such as a composition of the auxiliary layer 1322 or a sintering atmosphere. When the thickness of the auxiliary layer 1322 is too small, the possibility of cracks occurring in the battery main body 100 may increase. When the thickness of the auxiliary layer 1322 is too large, the shrinkage of the positive electrode margin unit 132 may be restricted to form an asymmetric all-solid-state battery 10.

The auxiliary layer of the positive electrode margin unit 132 may be formed by materials other than the above-described aluminum (Al). That is, the auxiliary layer 1322 of the positive electrode margin unit 132 may be formed using a material having a lower shrinkage rate than that of the solid electrolyte included in the main layer 1321. The auxiliary layer 1322 of the positive electrode margin unit 132 may be formed by a material which is easily oxidized in the air and has a specific gravity of 3 or lower. For example, the auxiliary layer 1322 of the positive electrode margin unit 132 may include magnesium (Mg), titanium (Ti), silicon (Si), or zirconium (Zr). However, the material included in the auxiliary layer 1322 of the positive electrode margin unit 132 is not limited thereto.

The auxiliary layer 1322 of the positive electrode margin unit 132 may further include acryl binder, solvent, and dispersing agent. The above-described acryl binder, solvent, and dispersing agent may be decomposed during the sintering and may not remain on the auxiliary layer 1322 of the positive electrode margin unit 132.

The main layer 1321 and the auxiliary layer 1322 may be laminated in the thickness direction (T axis direction). That is, the auxiliary layer 1322 may be disposed on the main layer 1321 or the main layer 1321 may be disposed on the auxiliary layer 1322. Even though in FIG. 5, it is illustrated that the main layer 1321 is disposed on the auxiliary layer 1322, the positions of the main layer 1321 and the auxiliary layer 1322 are not limited thereto. That is, the main layer 1321 may be disposed below the auxiliary layer 1322.

The main layer 1321 and the auxiliary layer 1322 may be defined as a first layer and a second layer or a second layer and a first layer. That is, the positive electrode margin unit 132 includes the first layer and the second layer having a lower shrinkage rate than that of the first layer. In the thickness direction (T axis direction), the first layer may be disposed on the second layer.

The negative electrode margin unit 152 may be disposed between the negative electrode layer 150 and the first external electrode 300 in the length direction (L axis direction). That is, the negative electrode margin unit 152 extends from an end portion of the negative electrode layer 150 toward the first surface S1 of the battery main body 100 in the length direction (L axis direction) to form a part of the first surface S1 of the battery main body 100. One end of the negative electrode layer 150 may be electrically connected to the second external electrode 400 and the other end of the negative electrode layer 150 may be in contact with the negative electrode margin unit 152 so that the negative electrode layer 150 is electrically insulated from the first external electrode 300 by the negative electrode margin unit 152.

The negative electrode margin unit 152 may be formed of an insulating material, that is, a material which does not have electron (ion) conductivity. The negative electrode margin unit 152 may include a glass-ceramic based electrolyte including lithium-halogen (LiX, X=halogen element such as F, Br, Cl, I). The glass-ceramic (or crystallized glass) refers to crystallographic mixture of an amorphous material and a crystalline material. For example, peaks or halos observed in the X-ray diffraction or electron beam diffraction may indicate a crystallographic mixture of amorphous and a crystalline material. Accordingly, the glass-ceramic based electrolyte is an electrolyte that has undergone some crystallization by the sintering and is in a mixed amorphous and crystalline state.

The glass-ceramic based electrolyte may be a mixture of amorphous and two or more crystalline phases. Further, the crystalline material may include in the glass-ceramic based electrolyte may include a lithium compound crystalline phase including lithium. The glass-ceramic based electrolyte includes lithium (Li) oxide, boron (B) oxide, silicon (Si) oxide, aluminum (Al) oxide, gallium (Ga) oxide, phosphorus (P) oxide, germanium (Ge) oxide, magnesium (Mg) oxide, and lithium chloride (LiCl). For example, the glass-ceramic based electrolyte may include Li₂O—B₂O—SiO₂—P₂O₅—GeO₂—LiCl.

For example, the negative electrode margin unit 152 includes alumina (Al₂O₃), aluminum nitride (AlN), beryllium oxide (BeO), boron nitride (BN), silicon (Si), silicon carbide (SiC), silica (SiO₂), silicon nitride (Si₃N₄), gallium arsenide (GaAs), gallium nitride (GaN), barium titanate (BaTiO₃), zirconium dioxide (ZrO₂), a mixture thereof, oxide and/or nitride of the materials, or other appropriate ceramic material. Further, the negative electrode margin unit 152 may selectively include the above-described solid electrolyte. However, the material of the negative electrode margin unit 152 is not limited thereto.

The negative electrode margin unit 152 may include a material having a low ion conductivity and low electron conductivity, that is, an insulating material, or include a material having ion conductivity (or electron conductivity) similar to the ion conductivity (or electron conductivity) of the solid electrolyte. For example, when a material having ion conductivity (or electron conductivity) similar to the ion conductivity (or electron conductivity) of the solid electrolyte is included in the main layer 1321 of the negative electrode margin unit 152, the material may be the same material as a solid electrolyte in another region or different material. As another example, both a material having ion conductivity (or electron conductivity) similar to the ion conductivity (or electron conductivity) of the solid electrolyte and an insulating material may be included in the negative electrode margin unit 132.

The positive electrode margin unit 132 and the negative electrode margin unit 152 may be defined as a first margin unit and a second margin unit or a second margin unit and a first margin unit.

The upper protection layer 180 and the lower protection layer 190 may be insulating layers which are formed of an insulating material, that is, a material which does not have electron conductivity (ion conductivity).

The upper protection layer 180 and the lower protection layer 190 may include a ceramic material, and for example, alumina (Al₂O₃), aluminum nitride (AlN), beryllium oxide (BeO), boron nitride (BN), silicon (Si), silicon carbide (SiC), silica (SiO₂), silicon nitride (Si₃N₄), gallium arsenide (GaAs), gallium nitride (GaN), barium titanate (BaTiO₃), zirconium dioxide (ZrO₂), a mixture thereof, oxide and/or nitride of the materials, or other appropriate ceramic material, but are not limited thereto. The upper protection layer 180 and the lower protection layer 190 selectively include the above-described solid electrolyte and include one or more type of solid electrolytes, but am not limited thereto.

The first external electrode 300 and the second external electrode 400 are provided at the outside of the battery main body 100.

The first external electrode 300 is connected to the positive electrode layer 130 on the first surface S1 of the battery main body 100 and the second external electrode 400 is connected to the negative electrode layer 150 on the second surface S2 of the battery main body 100. The first external electrode 300 is connected to the positive electrode layer 130 while covering the first surface S1 of the battery main body 100. The second external electrode 400 is connected to the negative electrode layer 150 while covering the second surface S2 of the battery main body 100.

For example, the first external electrode 300 extends from the first surface S1 to the third surface S3, the fourth surface S4, the fifth surface S5, and the sixth surface S6 of the battery main body 100 to partially cover each surface. Further, the second external electrode 400 extends from the second surface S2 to the third surface S3, the fourth surface S4, the fifth surface S5, and the sixth surface S6 of the battery main body 100 to partially cover each surface.

As another example, the first external electrode 300 extends from the first surface S1 to any one of the fifth surface S5 and the sixth surface S6 to partially cover the surface and the second external electrode 400 extends from the second surface S2 to any one of the fifth surface S5 and the sixth surface S6 to partially cover the surface.

The first external electrode 300 may include an electrode layer and a plating layer and the second external electrode 400 may include an electrode layer and a plating layer.

The first electrode layer 310 of the first external electrode 300 may be electrically connected to the positive electrode layer 130 and the second electrode layer 410 of the second external electrode 400 is electrically connected to the negative electrode layer 150.

For example, the first electrode layer 310 of the first external electrode 300 and the second electrode layer 410 of the second external electrode 400 may be sintering electrodes including a conductive metal and glass or a resin based electrode including a conductive metal and resin.

For example, the first electrode layer 310 of the first external electrode 300 and the second electrode layer 410 of the second external electrode 400 may be formed by applying a paste for terminal electrodes including a conductive metal on the first surface S1 and the second surface S2 of the battery main body 100 or formed by transferring a drying film obtained by drying the conductive paste onto the battery main body 100 and then sintering the film. However, the method for forming the first and second electrode layers 310 and 410 is not limited thereto. For example, the conductive metal which forms the first and second electrode layers 310 and 410 may be one or more of copper (Cu), nickel (Ni), tin (Sn), palladium (Pd), platinum (Pt), gold (Au), silver (Ag), tungsten (W), titanium (Ti), lead (Pb), and an alloy thereof.

The first plating layer 320 of the first external electrode 300 covers the first electrode layer 310 and the second plating layer 420 of the second electrode covers the second electrode layer 410. The first and second plating layers 320 and 420 serve to improve the mounting characteristic of the external electrode. The first and second plating layers 320 and 420 may include one or more selected from a group consisting of one or more of copper (Cu), nickel (Ni), tin (Sn), palladium (Pd), platinum (Pt), gold (Au), silver (Ag), tungsten (W), titanium (Ti), lead (Pb), and an alloy thereof, but are not limited thereto. The first and second plating layers 320 and 420 may be formed by one or more layers.

As described above, the positive electrode layer 130 may include a current collector 132 and a pair of positive electrode active material layers 135 disposed on both surfaces of the current collector 133. The negative electrode layer 150 may be formed by one negative electrode active material layer. A thickness of the positive electrode layer 130 may be defined by a sum of a thickness of the current collector 133 and a thickness of the positive electrode active material layer 135. The thickness of the negative electrode layer 150 may be defined by the thickness of the negative electrode active material layer. The thickness of the positive electrode layer 130 includes the thickness of the current collector 133 and the thickness of the positive electrode active material layer 135 so that the thickness of the positive electrode layer 130 is larger than the thickness of the negative electrode layer 150 which includes only the thickness of the negative electrode active material layer. As the difference in thickness between the positive electrode layer 130 and the negative electrode layer 150 is increased, the difference in thickness between the positive electrode margin unit 132 and the negative electrode margin unit 152 is also increased. Accordingly, a difference in a shrinkage rate difference between a region in which the positive electrode margin unit 132 is disposed and a region in which the negative electrode margin unit is disposed increases. Therefore, cracks may be caused due to the external stress during a process of sintering the battery main body 100. The cracks occurring in the battery main body 100 may cause the short defect. When a thickness ratio of the positive electrode layer 130 to the thickness of the negative electrode layer 150 is 1.2 or larger, the probability of crack occurrence is very high. According to the present embodiment, an auxiliary layer is interposed on positive electrode margin layers so that even when the thickness difference of the positive electrode layer and the negative electrode layer is large, for example, the ratio of the thickness of the positive electrode layer to the thickness of the negative electrode layer is 1.2 or larger, the crack occurring in the entire battery main body may be suppressed. Accordingly, the short defect of the all-solid-state battery is suppressed.

### Preparation Example: Preparation of all-Solid-State Battery

Under the condition of 550° C. and 10 Mpa, all-solid-state batteries of Examples 1 to 4 and Comparative Examples 1 to 4 were prepared. Each of all-solid-state battery was prepared to have 55 positive electrode layers and 55 negative electrode layers. Each of all-solid-state battery was prepared using a slurry having the following composition.

Positive electrode slurry (positive electrode active material layer printed): solid material (LCO 70 wt %, solid electrolyte 30 wt %), acryl binder (20 wt % of solid material), DOTP (plasticizer, 10 wt % of acryl binder), DHT (solvent, 30 wt % of solid material), and amine based dispersing agent (1 wt % of solid material)

Current collecting slurry (current collector printed): solid material (50 wt % of plate-shaped graphite, 50 wt % of solid electrolyte), acryl binder (20 wt % of solid material), DOTP (plasticizer, 10 wt % of acryl binder), DHT (solvent, 30 wt % of solid material), and amine based dispersing agent (1 wt % of solid material)

Negative electrode slurry (negative electrode layer printed): solid material (65 wt % of spherical graphite, 35 wt % of solid electrolyte), acryl binder (25 wt % of solid material), DOTP (plasticizer, 10 wt % of acryl binder), DHT (solvent, 30 wt % of solid material), and amine based dispersing agent (3 wt % of solid material)

Margin slurry 1 (main layer of positive electrode margin unit and negative electrode margin unit printed): solid material (100 wt % of solid electrolyte), acryl binder (30 wt % of solid material). DOTP (plasticizer, 10 wt % of acryl binder), DHT (solvent, 30 wt % of solid material), and amine based dispersing agent (3 wt % of solid material)

Margin slurry 2 (Auxiliary layer of positive electrode margin unit printed): solid material (80 wt % of aluminum powder and 20 wt % of solid electrolyte), acryl binder (30 wt % of solid material). DOTP (plasticizer, 10 wt % of acryl binder), DHT (solvent, 30 wt % of solid material), amine based dispersing agent (3 wt % of solid material)

### Example 1

An all-solid-state battery in which an average thickness of a positive electrode layer was 45 um and an average thickness of the negative electrode layer was 45 um was prepared in the battery main body. At this time, as the positive electrode margin unit, a main layer and an auxiliary layer were formed. The main layer was formed to have a thickness of 25 um using the margin slurry 1 and the auxiliary layer was formed to have a thickness of 20 urn using the margin slurry 2.

### Example 2

An all-solid-state battery in which an average thickness of a positive electrode layer was 50 um and an average thickness of the negative electrode layer was 40 um was prepared in the battery main body. At this time, as the positive electrode margin unit, a main layer and an auxiliary layer were formed. The main layer was formed to have a thickness of 30 um using the margin slurry 1 and the auxiliary layer was formed to have a thickness of 20 um using the margin slurry 2.

### Example 3

An all-solid-state battery in which an average thickness of a positive electrode layer was 55 um and an average thickness of the negative electrode layer was 45 urn was prepared in the battery main body. At this time, as the positive electrode margin unit, a main layer and an auxiliary layer were formed. The main layer was formed to have a thickness of 35 um using the margin slurry 1 and the auxiliary layer was formed to have a thickness of 20 um using the margin slurry 2.

### Example 4

An all-solid-state battery in which an average thickness of a positive electrode layer was 65 um and an average thickness of the negative electrode layer was 45 um was prepared in the battery main body. At this time, as the positive electrode margin unit, a main layer and an auxiliary layer were formed. The main layer was formed to have a thickness of 40 um using the margin slurry 1 and the auxiliary layer was formed to have a thickness of 20 um using the margin slurry 2.

### Comparative Example 1

1.1381 An all-solid-state battery in which an average thickness of a positive electrode layer was 45 um and an average thickness of the negative electrode layer was 45 um was prepared in the battery main body. At this time, the positive electrode margin unit was formed to have a thickness of 45 um using the margin slurry 1.

### Comparative Example 2

An all-solid-state battery in which an average thickness of a positive electrode layer was 50 um and an average thickness of the negative electrode layer was 45 un was prepared in the battery main body. At this time, the positive electrode margin unit was formed to have a thickness of 50 um using the margin slurry 1.

### Comparative Example 3

An all-solid-state battery in which an average thickness of a positive electrode layer was 55 um and an average thickness of the negative electrode layer was 45 um was prepared in the battery main body. At this time, the positive electrode margin unit was formed to have a thickness of 55 um using the margin slurry 1.

### Comparative Example 4

An all-solid-state battery in which an average thickness of a positive electrode layer was 60 um and an average thickness of the negative electrode layer was 45 um was prepared in the battery main body. At this time, the positive electrode margin unit was formed to have a thickness of 60 um using the margin slurry 1.

### Experimental Example: Measurement of Resistance of all-Solid-State Battery

After preparing a plurality of all-solid-state batteries of Exemplary Embodiments 1 to 4 and Comparative Examples 1 to 4, a resistance was measured to identify whether a short was generated.

TABLE 1

| | | | Positive electrode- | |
|---|---|---|---|---|
| | Positive electrode | Negative electrode | negative electrode | Measured |
| | layer thickness | layer thickness | layer thickness | resistance |
| | (um) | (um) | ratio | (Ω) |
| Comparative | 45 | 45 | 1.00 | 400 |
| Example 1 | | | | |
| Comparative | 50 | 45 | 1.11 | 400 |
| Example 2 | | | | |
| Comparative | 55 | 45 | 1.22 | short |
| Example 3 | | | | |
| Comparative | 60 | 45 | 1.33 | short |
| Example 4 | | | | |
| Example 1 | 45 | 45 | 1.00 | 550 |
| Example 2 | 50 | 45 | 1.11 | 600 |
| Example 3 | 55 | 45 | 1.22 | 700 |
| Example 4 | 60 | 45 | 1.33 | 700 |

Referring to Table 1, when the auxiliary layer was not applied and the difference in the thickness between the positive electrode layer and the thickness of the negative electrode layer was not large, the short was not generated (Comparative Examples 1 and 2). When the difference in the thickness between the positive electrode layer and the thickness of the negative electrode layer is large so that the thickness ratio of the positive electrode layer and the negative electrode layer was 1.22 or large, short defects were generated in all the products (Comparative Examples 3 and 4).

In Examples 1 to 4 in which an auxiliary layer is applied, a short was not generated. Particularly, even in Exemplary Embodiments 3 and 4 in which the thickness difference of the positive electrode layer and the negative electrode layer was large, the short defect was not generated. This is due to the improvement of the cracking symptoms caused by the difference in thickness between the positive electrode layer and the negative electrode layer.

Hereinafter, an all-solid-state battery according to another embodiment will be described with reference to FIG. 6 together with FIGS. 1 to 4.

FIG. 6 is a cross-sectional view which is enlarged like the method of FIG. 5 to explain an all-solid-state battery according to another embodiment. The all-solid-state battery according to the present embodiment is the same as the embodiment described with reference to FIGS. 1 to 5 excluding the positive electrode margin unit. A redundant description of the same configuration will be omitted.

Referring to FIG. 6, a positive electrode margin unit 232 of the all-solid-state battery according to the present embodiment may include a main layer 2321 and an auxiliary layer 2322. The main layer 2321 may include a first main layer 2321a and a second main layer 2321b. The first main layer 2321a and the second main layer 2321b face each other in the thickness direction (T axis direction) with the auxiliary layer 2322 therebetween. That is, in the thickness direction (T axis direction), the auxiliary layer 2322 is disposed on the first main layer 2321a and the second main layer 2321b is disposed on the auxiliary layer 2322. The first main layer 2321a and the second main layer 2321b may be formed of the same material. The auxiliary layer 2322 may include an inner region 2322a and a surface region 2322b, wherein the inner region 23322a has a shrinkage rate lower than those of the first main layer 2321a and the second main layer 2321b and the surface region 2322b has an insulating property. The material used for the auxiliary layer 2322 and the main layer 2321 is the same as the material of the auxiliary layer 1322 and the main layer 1321 of the embodiment which has been described with reference to FIG. 5 so that a detailed description will be omitted.

For example, the main layer 2321 may have the same composition as the solid electrolyte layer 110. That is, the main layer 2321 is formed by a solid electrolyte paste used to form the solid electrolyte layer 110. At this time, the main layer 2321 may be a part of the solid electrolyte layer 110 which extends to a side surface of the positive electrode layer 130.

The main layer 2321 having the same composition as the solid electrolyte layer 110 may be a part of the solid electrolyte layer 110 which extends in the thickness direction (T axis direction). That is, in the thickness direction (T axis direction), the solid electrolyte layer 110 disposed below the positive electrode layer 130 may extend upwards to form a first main layer 2321a and the solid electrolyte layer 110 disposed on the positive electrode layer 130 may extends downwards to form a second main layer 2321b.

Even though it is not illustrated, in the positive electrode margin unit, a plurality of auxiliary layers and main layers are alternately laminated, which also falls into the scope of the present invention.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

10: All-solid-state battery
100: Battery main body
110: Solid electrolyte layer
130: Positive electrode layer
1321: Main layer
1322: Auxiliary layer
133: Current collector
135: Positive electrode active material layer
150: Negative electrode layer
152: Negative electrode margin unit
180: Upper protection layer
190: Lower protection layer
300: First external electrode
400: Second external electrode

1. An all-solid-state battery, comprising:
a solid electrolyte layer;
a positive electrode layer and a negative electrode layer facing each other with the solid electrolyte layer therebetween;
a first external electrode connected to the positive electrode layer;
a second external electrode connected to the negative electrode layer; and
a positive electrode margin unit disposed between the positive electrode layer and the second external electrode,
wherein the positive electrode margin unit includes a main layer and an auxiliary layer having a shrinkage rate lower than that of the main layer.

2. The all-solid-state battery of claim 1, wherein
the main layer is disposed on the auxiliary layer in a direction which the positive electrode layer and the negative electrode layer face each other.

3. The all-solid-state battery of claim 1, wherein
the main layer comprises a first main layer and a second main layer, and
the auxiliary layer is disposed on the first main layer and the second main layer is disposed on the auxiliary layer, in a direction which the positive electrode layer and the negative electrode layer face each other.

4. The all-solid-state battery of claim 1, wherein
the auxiliary layer of the positive electrode margin unit comprises aluminum (Al).

5. The all-solid-state battery of claim 4, wherein
the auxiliary layer of the positive electrode margin unit comprises aluminum oxide in at least a part of a surface of the auxiliary layer.

6. The all-solid-state battery of claim 4, wherein
the auxiliary layer comprise, at least 10 wt % of solid electrolyte.

7. The all-solid-state battery of claim 1, wherein
the main layer of the positive electrode margin unit comprises a glass ceramic based electrolyte.

8. The all-solid-state battery of claim 1, wherein
a thickness of the positive electrode layer is larger than a thickness of the negative electrode layer, in a direction which the positive electrode layer and the negative electrode layer face each other.

9. The all-solid-state battery of claim 8, wherein
the positive electrode layer comprises a current collector and a pair of positive electrode active material layers disposed on both surfaces of the current collector,
the negative electrode layer comprises a negative electrode active material layer,
the thickness of the positive electrode layer is a sum of a thickness of the current collector and thicknesses of the pair of positive electrode active material layers, and
the thickness of the negative electrode layer is a thickness of the negative electrode active material layer.

10. The all-solid-state battery of claim 8, wherein
a ratio of the thickness of the positive electrode layer to the thickness of the negative electrode layer is 1.2 or higher.

11. The all-solid-state battery of claim 1, wherein
the positive electrode layer is connected to the first external electrode and the positive electrode layer is insulated from the second external electrode by the positive electrode margin unit.

12. An all-solid-state battery, comprising:
a first inner electrode layer;
a second inner electrode layer thicker than the first inner electrode layer;
a solid electrolyte layer disposed between the first inner electrode layer and the second inner electrode layer;
a first external electrode connected to the second inner electrode layer;
a second external electrode connected to the first inner electrode layer; and
a first margin unit which is disposed between the second inner electrode layer and the second external electrode,
wherein the first margin unit comprises a first layer and a second layer having a shrinkage rate lower than that of the first layer.

13. The all-solid-state battery of claim 12, wherein
the first layer is disposed on the second layer in a direction which the first inner electrode layer and the second inner electrode layer face each other.

14. The all-solid-state battery of claim 12, wherein
the second layer comprises aluminum (Al).

15. The all-solid-state battery of claim 14, wherein
the second layer comprises aluminum oxide on at least a part of a surface thereof.

16. An all-solid-state battery, comprising:
a solid electrolyte layer,
a positive electrode layer and a negative electrode layer facing each other with the solid electrolyte layer therebetween;
a first external electrode connected to the positive electrode layer;
a second external electrode connected to the negative electrode layer; and
a positive electrode margin unit disposed between the positive electrode layer and the second external electrode,
wherein the positive electrode margin unit includes a main layer and an auxiliary layer, and
a weight ratio of a weight of aluminum (Al) in the auxiliary layer to a total weight of the auxiliary layer is greater than a weight ratio of a weight of aluminum (Al) in the main layer to a total weight of the main layer.

17. The all-solid-state battery of claim 16, wherein
a weight ratio of a weight of solid electrolyte in the auxiliary layer to the total weight of the auxiliary layer is less than a weight ratio of a weight of solid electrolyte in the main layer to the total weight of the main layer.

18. The all-solid-state battery of claim 16, wherein
the main layer is disposed on the auxiliary layer in a direction which the positive electrode layer and the negative electrode layer face each other.

19. The all-solid-state battery of claim 16, wherein
a thickness of the positive electrode layer is larger than a thickness of the negative electrode layer, in a direction which the positive electrode layer and the negative electrode layer face each other.

20. The all-solid-state battery of claim 19, wherein
a ratio of the thickness of the positive electrode layer to the thickness of the negative electrode layer is 1.2 or higher.
